(19) United States
(12) Patent Application Publication
(10) Pub. No.: US 2021/0309360 A1
(43) Pub. Date: Oct. 7, 2021

(54) APPARATUS FOR AERIAL TRANSPORTATION OF PAYLOAD

(71) Applicant: Srinath MALLIKARJUNAN, Chennai (IN)

(72) Inventor: Srinath MALLIKARJUNAN, Chennai (IN)

(21) Appl. No.: 17/267,120

(22) PCT Filed: Sep. 3, 2019
(86) PCT No.: PCT/IN2019/050634

§ 371 Date: Feb. 9, 2021

(30) Foreign Application Priority Data
Sep. 11, 2018 (IN) 201821034204

(51) Int. Cl. B64C 39/02; B64C 27/10; B64D 27/02; B64D 27/24; B64C 27/68; B64C 27/80; B64C 27/82

(52) U.S. Cl. CPC B64C 39/024; F16D 43/04; B64D 27/02; B64D 27/24; B64C 27/68; B64C 27/80; B64C 27/82; B64C 2201/027; B64C 2201/044; B64C 2201/108; B64C 2201/128; B64C 2201/165; B64C 2201/042; B64C 2027/8227; B64C 27/10

(57) ABSTRACT

Disclosed is an apparatus (100) for an aerial transportation of a payload. The apparatus (100) includes a propeller unit (10) to provide a primary thrust whereas a plurality of propellers (50) is fitted around a body of the apparatus (100) to help in maneuvering and orientation control. The apparatus (100) employs gasoline as a primary source of energy that has a higher energy density than lithium polymer batteries. The apparatus (100) facilitates longer flight times. The apparatus (100) is useful for safe transportation of higher payloads and has vertical takeoff and land capability.

### FIELD OF THE INVENTION

The present disclosure relates generally to payload transportation and more particularly, to an apparatus for an aerial transportation of the payload.

### BACKGROUND OF THE INVENTION

With the advent of technology, the job of transporting payloads, that has been conventionally restricted to the land and the seas, has literally reached for the skies. Specialized contraptions are already available in the market that caters to transporting payloads of a spectrum as wide as pizzas to automobiles.

The apparatuses existing in the market, responsible for aerial transportation of payloads ranging from 10 to 100 kg have a limited flight time as these apparatuses employ lithium polymer batteries that have a small energy density. Further, these apparatuses use the same propellers for primary thrust and control in multi rotors. Moreover, the few devices presently available in the market are unable to transport payloads for extended periods of time and also incapable of hovering.

Accordingly, there exists a need to provide an apparatus for an aerial transportation of a payload that overcomes the above mentioned drawbacks of the prior arts.

### OBJECTS OF THE INVENTION

An object of the present invention is to provide a cost efficient and a safe apparatus for aerial transportation of payload.

Another object of the present invention is to provide an apparatus for aerial transportation of payload which is less demanding in terms of infrastructure requirements for take-off and landing.

### SUMMARY OF THE INVENTION

Accordingly, the present invention provides an apparatus for an aerial transportation of a payload. In an embodiment, the apparatus is a drone. In another embodiment, the apparatus is a drone operating on a technology of a vertical take-off and landing.

The apparatus comprises a propeller unit, a gearbox, an engine, a clutch, a plurality of propellers and an electrical subsystem.

The propeller unit is used to provide a primary thrust to the apparatus. The propeller unit includes a pair of top blades and a pair of bottom blades. The pair of top blades and the pair of bottom blades are arranged in a coaxial counter-rotating configuration. The pair of top blades is connected to the gearbox through an internal shaft that is concentric with a shaft. The propeller unit rotates in any one of a collective mode and a differential pitch mode. In the collective mode, the pair of top blades and the pair of bottom blades are deflected equally. In the differential pitch mode, the pair of top blades and the pair of bottom blades are deflected by different amounts/values.

The engine is used for driving the propeller unit through the gearbox. The clutch is positioned between the engine and the gearbox. The clutch disengages in case of failure of the engine to facilitate auto-rotation thereby enabling a safe descent. The plurality of propellers is fitted around a body of the apparatus. The plurality of propellers fitted around the body of the apparatus is in a range of 3 to 16. The plurality of propellers is fixed-pitch propellers that are powered by a plurality of electric motors. The plurality of propellers is adapted to help in maneuvering and orientation control. The electrical subsystem consists of a battery and electronic speed controllers for controlling speed of the plurality of propellers. Specifically, the electrical subsystem is used to change roll and pitch attitudes of the apparatus.

### BRIEF DESCRIPTION OF THE DRAWINGS

The objects and advantages of the present invention will become apparent when the disclosure is read in conjunction with the following figures, wherein

FIG. 1 illustrates a first perspective view of an apparatus for an aerial transportation of a payload, in accordance with the present invention;

FIG. 2 illustrates a second perspective view of the apparatus for the aerial transportation of the payload of FIG. 1;

FIG. 3 shows a side view of a propeller unit of the apparatus for the aerial transportation of the payload, in accordance with the present invention;

FIG. 4 shows a perspective view of the propeller unit of the apparatus for the aerial transportation of the payload, in accordance with the present invention; and

FIG. 5 shows a top view of the propeller unit of the apparatus for the aerial transportation of the payload, in accordance with the present invention.

### DETAILED DESCRIPTION OF THE INVENTION

The foregoing objects of the invention are accomplished and the problems and shortcomings associated with prior art techniques and approaches are overcome by the present invention described in the present embodiments.

The present invention provides an apparatus for an aerial transportation of a payload. The apparatus facilitates longer flight times. The apparatus is useful for safe transportation of higher payloads. The apparatus has vertical takeoff and land capability. The apparatus employs gasoline as a primary source of energy that has a higher energy density than lithium polymer batteries.

The present invention is illustrated with reference to the accompanying drawings, throughout which reference numbers indicate corresponding parts in the various figures. These reference numbers are shown in bracket in the following description.

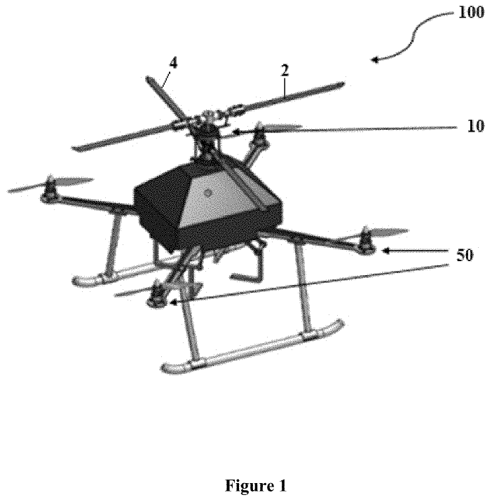

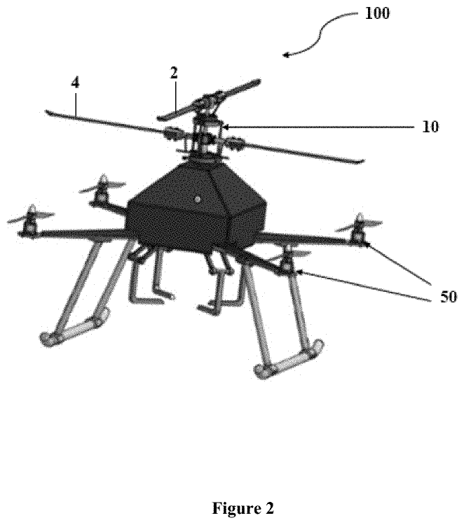

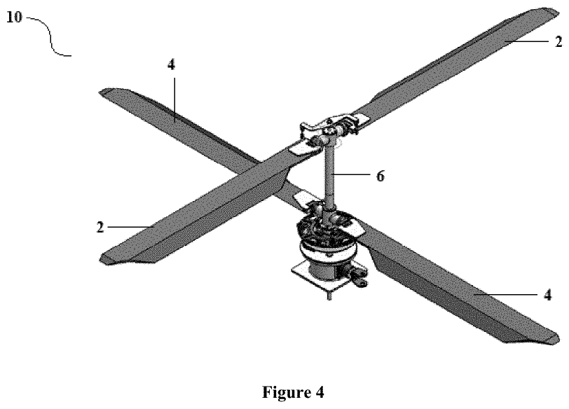

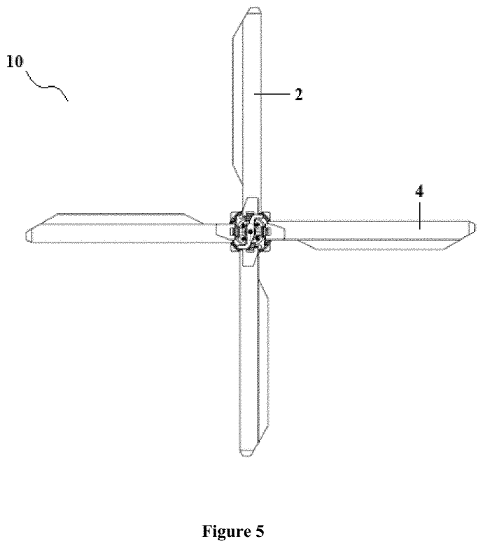

Referring to FIGS. 1-5, an apparatus (100) for an aerial transportation of a payload in accordance with the present invention is shown. In an embodiment, the apparatus (100) for the aerial transportation of the payload is a drone. In another embodiment, the apparatus (100) for the aerial transportation of the payload is a drone operating on a technology of a vertical take-off and landing (VTOL).

The apparatus (100) comprises a propeller unit (10), a gearbox (20), an engine (30), a clutch (40), a plurality of propellers (50) and an electrical subsystem (not shown).

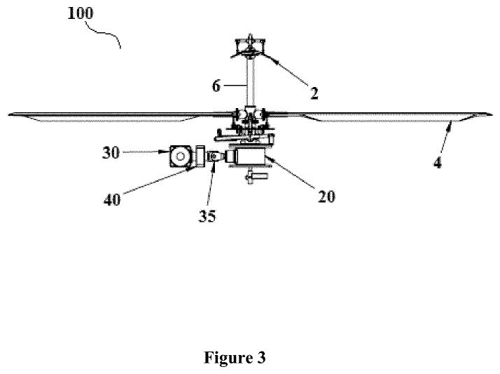

The propeller unit (10) provides a primary thrust to the apparatus (100) for take-off. As shown in FIGS. 3-5, the propeller unit (10) is a variable pitch twin coaxial counter-rotating propeller unit (10). The propeller unit (10) includes a pair of top blades (2) and a pair of bottom blades (4). Typically, the pair of top blades (2) and the pair of bottom blades (4) in the propeller unit (10) rotate at equal but opposite rotations per minute (rpm). The pair of top blades (2) is connected to the gearbox (20) through an internal shaft (not shown) that is concentric with a shaft (6). Specifically, the pair of top blades (2) and the pair of bottom blades (4) are arranged in a coaxial counter-rotating configuration.

The propeller unit (10) operates in any one of a collective mode and a differential pitch mode. In the collective mode, both blades (2, 4) are deflected equally. In the differential pitch mode, the pair of top blades (2) and the pair of bottom blades (4) are deflected by different amounts/values.

The propeller unit (10) is directly driven by the engine (30) through the gearbox (20). In an embodiment, the engine (30) is an internal combustion (IC) engine. The gearbox (30) includes gears that are selected from bevel gears, planetary gears and the like. As the propeller unit (10) is directly powered by the IC engine, the full power of the engine (30) is harnessed to produce the primary thrust. Further, the presence of the coaxial counter-rotating configuration of the propeller unit (10) eliminates the need for a tail rotor.

The clutch (40) is positioned between the engine (30) and the gearbox (20). The clutch (40) is connected to the gearbox (20) through a coupling (35). Typically, the clutch (40) disengages in case of failure of the engine (30) to facilitate auto-rotation thereby enabling a safe descent.

The plurality of propellers (50) is provided around a frame/body of the apparatus (100). In an embodiment, the plurality of propellers (50) is fixed-pitch propellers that are powered by a plurality of electric motors (not shown). The plurality of propellers (50) is adapted to help in maneuvering and orientation control. The plurality of propellers (50) is used for roll pitch and yaw control of the apparatus (100). In an embodiment, the propellers (50) fitted around the body of the apparatus (100) are in a range of 3 to 16. However, it is understood here that the number of propellers (50) fitted around the body of the apparatus (100) may vary in other alternative embodiments of the apparatus (100).

The electrical subsystem consists of a battery (not shown) and electronic speed controllers (not shown). The battery and the electronic speed controllers are used to control the speed of the plurality of propellers (50). In an embodiment, the electrical subsystem is powered by lithium polymer batteries and/or onboard power generation. In another embodiment, the battery is recharged by an alternator (not shown) mounted on-shaft or off-shaft on the engine (30).

In accordance with the present invention, the tasks of primary thrust and control of the apparatus (100) are carried out by two different subsystems that operate in their areas of respective strengths. Furthermore, the apparatus (100) employs gasoline as a primary source of energy that has a higher energy density than lithium polymer batteries.

Again referring to FIG. 1, in an operation, the payload to be transported is attached to the apparatus (100). Specifically, the payload is either slung under the apparatus (100) or carried on a side of the apparatus (100). The payload is attached to the apparatus (100) by a variety of methods including clamps, hooks and the like. The apparatus (100) is fueled with the gasoline. Thereafter, the engine is started which in turn runs the alternator causing the battery of the electrical subsystem to get charged. The clutch (40) gets engaged with the engine (30) when the engine rpm crosses a threshold. The clutch (40) then facilitates connection of the gearbox (20) to the engine (30).

The primary thrust of the apparatus (100) comes from the propeller unit (10) that is driven directly by the engine (30). The vertical movement of the apparatus (100) is controlled by adjusting the angle of the pair of top blades (2) and the pair of bottom blades (4). The pitch of the pair of top blades (2) and the pair of bottom blades (4) is adjusted to control the yaw of the apparatus (100). The pitch and roll attitude of the apparatus (100) is controlled by the plurality of electric motors and the plurality of propellers (50) fitted around the body of the apparatus (100). The payload when transported to a required destination is released either manually or through a servo release mechanism. In accordance with the present invention, the weight of the payload to be transported depends on the power of the engine (30) and the size of the propeller unit (10).

During descent, the deflection of the blades (2, 4) is gradually reduced causing the apparatus (100) to slowly descend. Longitudinal and lateral stability are maintained using the plurality of propellers (50). Once the apparatus (100) has safely landed, the engine (30) is switched off and the electric motors are shut down.

### Advantages of the Invention

1. The apparatus (100) facilitates longer flight times.
2. The apparatus (100) is useful for safe transportation of higher payloads.
3. The apparatus (100) has vertical takeoff and land capability.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

I claim:

1. An apparatus (100) for an aerial transportation of a payload, the apparatus (100) comprising:
a propeller unit (10) having a pair of top blades (2) and a pair of bottom blades (4) arranged in a coaxial counter-rotating configuration, the propeller unit (10) cable of rotating in any one of a collective mode and a differential pitch mode;
an engine (30) for driving the propeller unit (10) through a gearbox (20);
a clutch (40) positioned between the engine (30) and the gearbox (20), the clutch (40) capable of disengaging in case of failure of the engine (30) to facilitate auto-rotation thereby enabling a safe descent;
a plurality of propellers (50) fitted around a body thereof, the plurality of propellers (50) adapted to help in maneuvering and orientation control; and
an electrical subsystem consisting of a battery and electronic speed controllers for controlling speed of the plurality of propellers (50).

2. The apparatus (100) as claimed in claim 1 is a drone.

3. The apparatus (100) as claimed in claim 1 is a drone operating on a technology of a vertical take-off and landing.

4. The apparatus (100) as claimed in claim 1, wherein the propeller unit (10) provides a primary thrust to the apparatus (100).

5. The apparatus (100) as claimed in claim 1, wherein the pair of top blades (2) is connected to the gearbox (20) through an internal shaft that is concentric with a shaft (6).

6. The apparatus (100) as claimed in claim 1, wherein in the collective mode, both blades (2, 4) of the propeller unit (10) are deflected equally.

7. The apparatus (100) as claimed in claim 1, wherein in the differential pitch mode, the pair of top blades (2) and the pair of bottom blades (4) are deflected by different values.

8. The apparatus (100) as claimed in claim 1, wherein the plurality of propellers (50) is fixed-pitch propellers that are powered by a plurality of electric motors.

9. The apparatus (100) as claimed in claim 1, wherein the plurality of propellers (50) fitted around the body of the apparatus (100) are in a range of 3 to 16.

10. The apparatus (100) as claimed in claim 1, wherein the electrical subsystem is used to change roll and pitch attitudes of the apparatus (100).
